(19) United States
(12) Patent Application Publication
(10) Pub. No.: US 2009/0095460 A1
(43) Pub. Date: Apr. 16, 2009

(54) STRIPE-INTERWOVEN CAPILLARY STRUCTURE AND MANUFACTURING METHOD THEREOF

(76) Inventors: Cheng-Tu WANG, Sanchung (TW); Pang-Hung Liao, Sanchung (TW); Kuo-Feng Tseng, Sanchung (TW)

Correspondence Address: HDLS Patent & Trademark Services, P.O. BOX 220746, CHANTILLY, VA, 20153-0746, US

(21) Appl. No.: 11/870,572

(22) Filed: Oct. 11, 2007

(51) Int. Cl. F28F 1/00; D03D 1/00; F16L 11/02

(52) U.S. Cl. 165/177; 138/123; 139/1 R

(57) ABSTRACT

A capillary structure includes a bare core shown as a long rod shape; and a capillary layer wound around the bare core and covered a surrounding thereof. The capillary layer is constructed by strands that are woven in a plurality of directions (i.e. curly interwoven) and continuously wound around an outer surrounding of the bare core. In the meantime, each woven strands is a strand bundled from a weaving material.

### BACKGROUND OF THE INVENTION

1. Field of the Invention

The present invention generally relates to a capillary texture, in particular, to a capillary structure for providing a transportation of working fluid applicable in a heat pipe, and to a manufacturing method thereof.

2. Description of Prior Art

According to the prior arts of a heat pipe or a heat plate, a capillary texture is arranged therein for providing a transporting function to an internally working fluid. Generally, the configurations of the prior capillary textures can be divided into: channel type, sinter type, fiber type, and web type, etc. The common characteristic of these capillary textures is that they all have to be attached to the inner wall of the heat pipe or the heat plate.

In order to provide a further transporting effect to the working fluids, an “Auxiliary Capillary Structure” is further installed in the heat pipe for enhancing the aforementioned functions, as disclosed in “Heat Conducting Pipe” with Taiwanese (ROC) Patten No. I265270.

The auxiliary capillary structure is mainly constructed by weaving a plurality of filaments or by sintering a plurality of micro-particles in a way, such that the auxiliary capillary structure become a hollow round pipe installed in a heat pipe. On one hand, if the auxiliary capillary structure is configured by weaving the filaments, an inner wall of the heat pipe or the heat plate still have to be provided for the attaching effect, because the filaments are delicate and soft. On the other hand, if the auxiliary capillary structure is configured by sintering particles, the sintered object still has to be separated from the mold after a sintering process. This separating process sometimes causes the sintered object a damage, which influences the capillary transporting performance. In the mean time, because the sintered object is hard and brittle, if not fixed to the inner walls of a heat pipe or heat plate, the auxiliary capillary structure is easily cracked to lose its capillary transporting capability due to the occurrence of shaking or knocking.

Accordingly, aiming to solve aforementioned shortcomings, after a substantially devoted study, in cooperation with the application of relatively academic principles, the inventor has finally proposed the present invention that is designed reasonably to possess the capability to improve the prior arts significantly.

### SUMMARY OF THE INVENTION

The invention is mainly to provide a stripe-interwoven capillary structure and a manufacturing method thereof, which has independently supporting capability and flexibility to be bended and transformed into a suitable shape according to any actually applying situation. In the meanwhile, when applied in a heat pipe or a heat plate, it is unnecessary to inflexibly attach the structure to the inner walls of the heat pipe or the heat plate. The stripe-interwoven capillary structure of the invention is indeed a structure that may be existed independently.

The invention is to provide a stripe-interwoven capillary structure, including: a bare core, shown as a long rod shape; and, a capillary layer, wound around the bare core and covered a surrounding thereof. The capillary layer is constructed by strands that are woven in a plurality of directions (i.e. curly interwoven) and continuously wound around the outer surrounding of the bare core. In the meantime, each woven strands is a strand bundled from a weaving material. Thereby, aforementioned capillary structure is constructed.

The invention is further to provide a manufacturing method, of stripe-interwoven capillary structure, including following steps:
a) providing a metallic rod and a plurality of weaving materials;
b) making the metallic rod as a center, around which each weaving materials continuously wound by an interweaving manner, in the meantime, and covered which in a longitudinal direction; and
c) a product being completed, after each weaving materials having covered the entire length of the metallic rod.

### BRIEF DESCRIPTION OF DRAWING

The features of the invention believed to be novel are set forth with particularity in the appended claims. The invention itself, however, may be best understood by reference to the following detailed description of the invention, which describes several exemplary embodiments of the invention, taken in conjunction with the accompanying drawings, in which:

FIG. 1 is a perspective illustration of a capillary structure according to the present invention;

FIG. 2 is a perspective illustration of a bare core of a capillary structure according to the present invention;

FIG. 3 is a perspective illustration of another preferable embodiment of a bare core of a capillary structure according to the present invention;

FIG. 4 is a flowchart of a manufacturing method according to the present invention;

FIG. 5 is a machining illustration of a manufacturing method according to the present invention;

FIG. 6 is a cross-sectional illustration of the present invention applied in a heat pipe;

FIG. 7 is a cross-sectional illustration of a “6-6” part in FIG. 5;

FIG. 8 is a cross-sectional illustration of another preferable embodiment of the present invention applied in a heat pipe;

FIG. 9 is a cross-sectional illustration of a further preferable embodiment of the present invention applied in a heat pipe;

FIG. 10 is a cross-sectional illustration of the present invention applied in a heat pipe; and

FIG. 11 is a cross-sectional illustration of a further another preferable embodiment of the present invention applied in a heat pipe.

### DETAILED DESCRIPTION OF THE INVENTION

In cooperation with attached drawings, the technical contents and detailed description of the present invention are described thereinafter according to a number of preferable embodiments, being not used to limit its executing scope. Any equivalent variation and modification made according to appended claims is all covered by the claims claimed by the present invention.

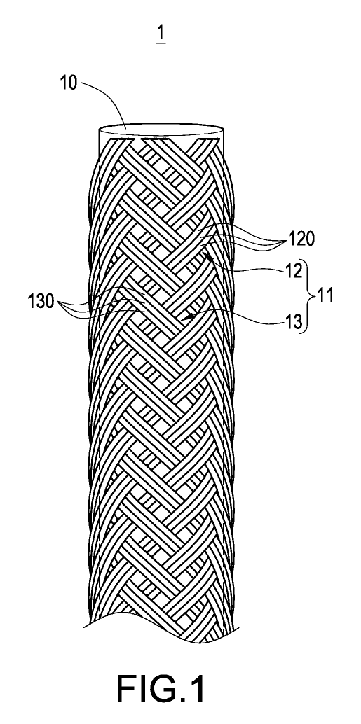

Please refer to FIG. 1, which is a perspective illustration of a capillary structure according to the present invention. The invention is to provide a stripe-interwoven capillary structure and a manufacturing method thereof. The stripe-interwoven capillary structure 1 includes: a bare core 10; and, a capillary layer 11 wound around and covered over the bare core 10.

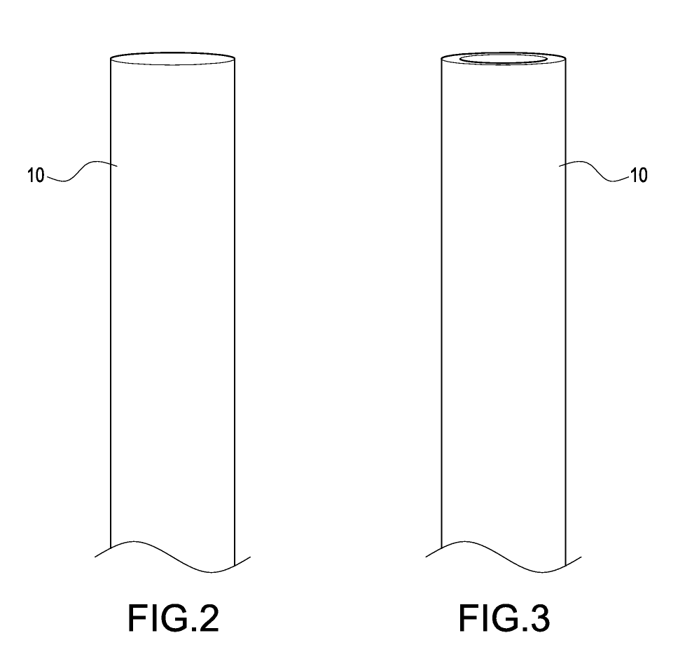

According to a preferable embodiment, as shown in FIG. 2 and FIG. 3, the bare core 10 may be any metallic rod, with stripe shape or rod shape, made of metallic materials, with excellent heat conductivity, such as, copper or aluminum. The bare core 10 is mainly used to constitute a skeleton of aforementioned capillary structure 1, so that the capillary structure 1 has an independently supporting capability to be able to be bended and transformed through the flexibility of the bare core 10. In addition, the bare core 10 can also be configured according to diameter size. When the diameter is small, the bare core 10 can be made as a solid configuration. When the diameter is large, the bare core 10 can be made as a hollow one.

Again, please refer to FIG. 1. The capillary layer 11 is made by at least two weaving strands 12, 13, which are respectively curly interwoven in orthogonal or oblique manner, and which are also continuously wound around aforementioned bare core 10 along a longitudinal direction, while each weaving strands 12, 13 can be constituted by a single or a plurality of weaving materials 120, 130. In this preferable embodiment, the weaving strands 12, 13 are curly interwoven in two oblique directions, while each weaving strands 12, 13 are a strand bundled by three stripes of weaving materials 120, 130. Each weaving materials 120, 130 may be metallic or graphitic filament. The metallic filament may be made of metallic wire with excellent heat conductivity, generally, for example, copper wire. The graphitic filament may be graphitized from the material of carbon fiber.

Therefore, according to aforementioned structural constitution, it is possible to obtain a stripe-interwoven capillary structure of the present invention.

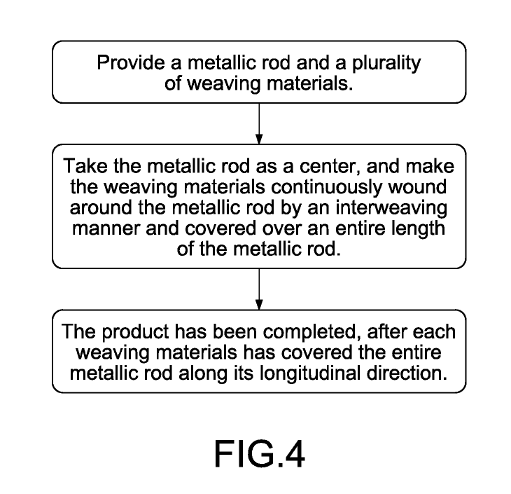

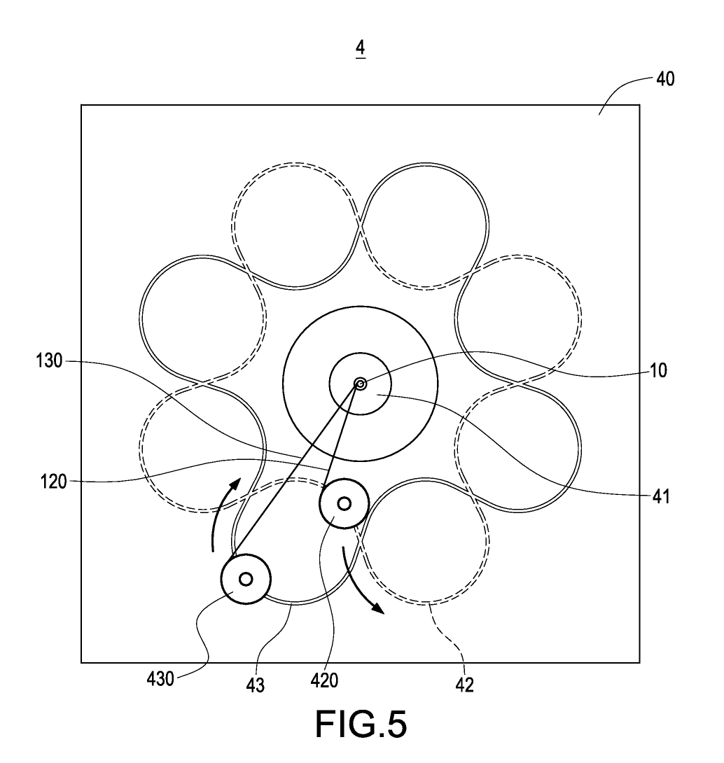

Please refer to FIG. 4, which is a flowchart of a manufacturing method of the present invention. The manufacturing method of a stripe-interwoven capillary structure 1 according to the present invention may be accomplished from following steps:
a) First, prepare a metallic rod (i.e. aforementioned bare core 10) and a plurality of weaving materials 120, 130 as the needed materials for manufacturing the capillary structure 1.
b) Second, take aforementioned metallic rod as a center, make each weaving materials 120, 130 continuously wound around the metallic rod by an interweaving manner and covered over the metallic rod along a longitudinal direction. Please refer to FIG. 5 altogether. In this step, a machine 4 is used for execution and includes: a base 40, on a center of which a mandrel 41 is arranged; two rails 42, 43, formed as “S”-shaped routes, intercrossed to each other, and surrounded the surrounding of the mandrel 41; and, at least one material barrel 420, 430, respectively arranged at each rails 42, 43, for providing weaving materials 120, 130 to aforementioned bidirectional weaving strands 12, 13, and respectively rotated around the surrounding of the mandrel 41 in a clockwise and counterclockwise directions along each corresponding rails 42, 43. Thereby, the bidirectional weaving materials 120, 130 are wound around in counter directions and interwoven to each other. The interwoven weaving materials 120, 130 are wound around a metallic rod (i.e. the aforementioned bare core 10) self-rotated by the mandrel 41. The metallic rod is being self-rotated, when it is moving forward, making a self-rotation along a spiral route, such that each weaving materials 120, 130 are wound around and covered over the metallic rod in a longitudinal direction. In addition, in order to promote production performance, it is necessary to accelerate the rotating speed of the metallic rod, making weaving materials 120, 130 being able to be wound around the metallic in a more quick way. In the meantime, a plurality of material barrels 420, 430 are respectively arranged at each rails 42, 43, such that a plurality of spiral threads can be quickly wound around the metallic rod, and a production performance may be enhanced.
c) Finally, a finished product of capillary structure 1 is accomplished, after each weaving materials 120, 130 have covered over the entire length of the metallic rod.

Thereby, according to the flowchart mentioned thereinbefore, it is possible to obtain a manufacturing method for a stripe-interwoven capillary structure of the present invention.

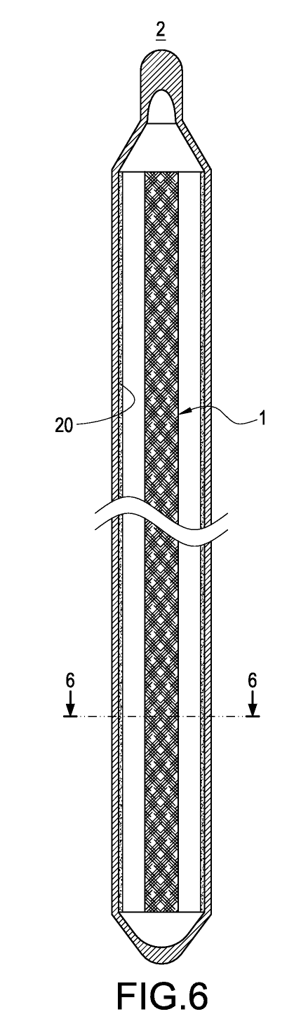

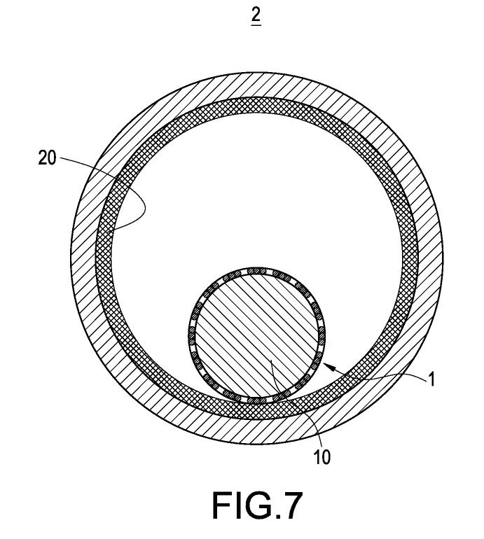

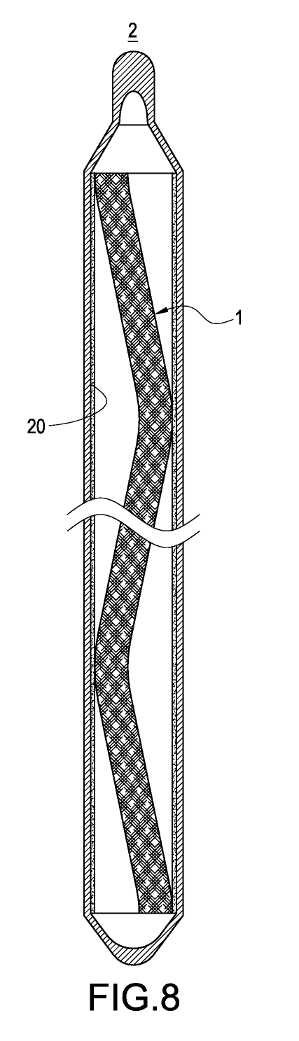

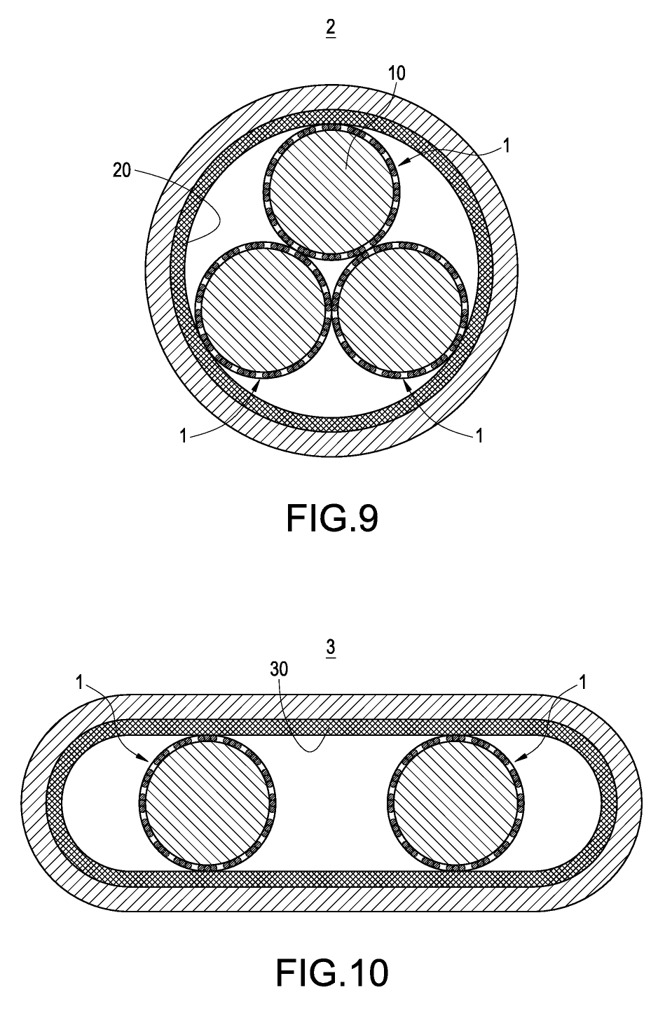

As shown in FIG. 6 and FIG. 7, the capillary structure 1 may be applied in an ordinary heat pipe 2, namely, coexisted with a capillary texture 20 originally installed in the heat pipe 2. As shown in FIG. 8, besides an independently supporting capability given by the bare core 10, the capillary structure 1 can be bent into any needed shapes and positioned in any place of the heat pipe 2 according to any actual situation. Of course, as shown in FIG. 9, it is also allowable to dispose a plurality of capillary structures 1 of the present invention in a heat pipe 2 simultaneously.

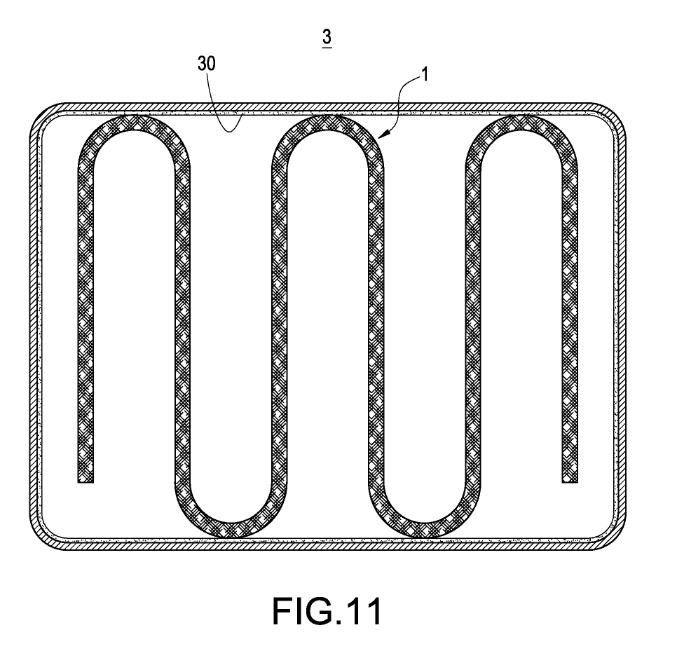

In addition, as shown in FIG. 10, it is also possible to apply a capillary structure 1 of the invention to a common heat plate 3 and to be coexisted with a capillary texture 30 thereof. In the meantime, a plurality of capillary structures 1 of the present invention can also be installed therein, depending upon an available space provided by the heat plate 3. Furthermore, as shown in FIG. 11, the flexibility of the bare core 10 of the capillary structure 1 can be applied in a way, for example, by bending the capillary structure 1 into a continuously curve “S” shape, such that it can be positioned in the heat plate 3.

Summarizing aforementioned description, the invention is an indispensable product of novelty indeed, which may positively reach the expected usage objective for solving the drawbacks of the prior arts, and which extremely possesses the innovation and progressiveness for completely fulfilling the applying merits of new type patent, according to which the invention is thereby applied. Please examine the application carefully and grant it as a formal patent for protecting the rights of the inventor.

However, the aforementioned description is only a number of preferable embodiments according to the present invention, being not used to limit the patent scope of the invention, so equivalently structural variation made to the contents of the present invention, for example, description and drawings, is all covered by the claims claimed thereinafter.

What is claimed is:

1. A stripe-interwoven capillary structure, including:
a bare core, shown as a long rod shape; and,
a capillary layer, constructed by strands woven in a plurality of directions to be curly interwoven and continuously wound around an outer surrounding of the bare core, each woven strands being a strand bundled from a weaving material.

2. The stripe-interwoven capillary structure according to claim 1, wherein the bare core is a metallic rod.

3. The stripe-interwoven capillary structure according to claim 1, wherein the bare core is a solid object.

4. The stripe-interwoven capillary structure according to claim 1, wherein the bare core is a hollow object.

5. The stripe-interwoven capillary structure according to claim 1, wherein each woven strands is a strand bundled from a plurality of weaving materials.

6. The stripe-interwoven capillary structure according to claim 1, wherein the weaving material is a graphitic filament.

7. The stripe-interwoven capillary structure according to claim 1, wherein the weaving material is a metallic filament.

8. The stripe-interwoven capillary structure according to claim 7, wherein the metallic filament is a copper wire.

9. A manufacturing method for a stripe-interwoven capillary structure, including following steps:
a) providing a metallic rod and a plurality of weaving materials;
b) taking the metallic rod as a center, and making the weaving materials continuously wound around the metallic rod by an interweaving manner and covered over an entire length of the metallic rod; and
c) having the weaving materials covered the entire metallic rod along a longitudinal direction thereof.

10. The manufacturing method for a stripe-interwoven capillary structure according to claim 9, wherein the metallic rod in step b) is made of a metallic material chosen from copper or aluminum.

11. The manufacturing method for a stripe-interwoven capillary structure according to claim 9, wherein the weaving material in step a) is a graphitic filament.

12. The manufacturing method for a stripe-interwoven capillary structure according to claim 9, wherein the weaving material in step a) is a metallic wire.

13. The manufacturing method for a stripe-interwoven capillary structure according to claim 12, wherein the metallic filament in step a) is a copper wire.

14. The manufacturing method for a stripe-interwoven capillary structure according to claim 9, wherein each weaving materials in step b) is respectively wound around the metallic rod in a clockwise and a counterclockwise directions and intercrossed to construct an interwoven structure during the winding procedure.

15. The manufacturing method for stripe-interwoven capillary structure according to claim 14, wherein a winding route of each weaving materials in step b) is an “S” shape, and wherein the routes in clockwise and counterclockwise directions are intercrossed to each other.

16. The manufacturing method for a stripe-interwoven capillary structure according to claim 9, wherein the metallic rod is self-rotated and moved forward simultaneously to wind the interwoven materials around the metallic rod, during an interweaving motion of each weaving materials.
